(19) United States
(12) Patent Application Publication
(10) Pub. No.: US 2024/0428150 A1
(43) Pub. Date: Dec. 26, 2024

(54) SYSTEM AND METHOD FOR IMPROVED TRADING WITH AGENT RANKING AND SCHEDULE TAGGING

(71) Applicant: NICE LTD., Ra'anana (IL)

(72) Inventors: Priyanka PADALALU, Pune (IN); Ruchika PASHINE, Pune (IN); Vaibhav CHOBE, Pune (IN)

(21) Appl. No.: 18/822,518

(22) Filed: Sep. 3, 2024

Related U.S. Application Data
(63) Continuation-in-part of application No. 17/367,369, filed on Jul. 4, 2021.

(51) Int. Cl. G06Q 10/0631; H04M 3/51

(52) U.S. Cl. CPC G06Q 10/06311; H04M 3/5175; H04M 2203/402; H04M 2203/558

(57) ABSTRACT

A computerized-method for trading a scheduled-working-shift, is provided herein. The computerized-method includes operating a trading-shifts module. The module includes: communicating with a computerized-device of a source-agent, to receive a trade-request for a scheduled-working-shift, via a trading-shift-interface; retrieving from a database, adequate target-agents, which have tagged a period including the scheduled-working shift as tradable and having a day off, during the scheduled-working-shift; calculating a trading-rank to each agent of the adequate target-agents, based on a number of trading actions in a preconfigured period of time in which the adequate target-agent has accepted a trade request, sorting the adequate target-agents, in descending order according to the calculated trading-rank of each agent of the adequate target-agents, to yield a sorted list of target-agents having a top-rated target-agent; and automatically updating the database, by assigning the scheduled-working-shift of the source-agent to the top-rated target-agent and the scheduled-working-shift of the top-rated target-agent to the source-agent.

### RELATED APPLICATIONS

This application claims priority as a continuation in part from application Ser. No.: 17/367,369 dated Jul. 4, 2021, the disclosure of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data analysis for trading a scheduled-working-shift based on an indication of agents' availability or based on an indication of agents' flexibility to swap shifts.

### BACKGROUND

In contact centers, agents are scheduled on a working-shift, based on the contact center staffing requirements. Due to personal reasons or other reasons, a scheduled agent may not be available on a scheduled-working-shift and may try to trade the scheduled-working-shift with another agent via a Workforce Management (WFM) system. The agent that is unavailable for a scheduled-working-shift is named a source-agent and each agent that might be willing to take the scheduled-working-shift and give up one of the scheduled-working-shifts, is named a target-agent.

In current WFM solutions in contact centers, a source-agent has to manually select target-agents having a working-scheduled-shift, with whom the source-agent wants to trade the working-scheduled-shift and to submit a trade request which will notify the selected target-agents.

In a contact center with a size of 1000 agents, the source-agent might manually select target-agents for the scheduled-working-shift trade from a list of agents, however it may result with redundant trade requests to uninterested target-agents and missed opportunity to those target-agents who could be interested in shift trade. This problem might worsen when of a large contact center with ˜30K to ˜40K agents.

In case none of the target-agents accepts the shift trade request of the source-agent, then it might result with the source-agent taking a day off during the scheduled-working-shift, due to the agent's personal reasons which may result with the particular scheduled-working-shift being understaffed.

Contact center staffing levels may also get affected due to an unavailability of agents, which may require a manual intervention by a supervisor for searching and reassigning the scheduled-working-shift to other available agents with the same set of skills as the unbailable agent.

Furthermore, when the attempt of an agent to trade a scheduled-working-shift fails, it may reduce the flexibility to work with the contact center and even hamper Employee Satisfaction (ESAT) score of the contact center.

Accordingly, there is a need for a technical solution for trading a scheduled-working-shift which may reflect the agents' flexibility to trade a scheduled-working-shift.

### SUMMARY

There is thus provided, in accordance with some embodiments of the present disclosure, a computerized-method for trading a scheduled-working-shift.

Furthermore, in accordance with some embodiments of the present disclosure, in a computerized system that includes a processor, and a memory including a database of a plurality of agents with a respective plurality of days off and scheduled-working-shifts which are stored thereon, the processor may be operating a trading-shifts module.

Furthermore, in accordance with some embodiments of the present disclosure, the trading-shifts module may include: (i) communicating with a computerized-device of a source-agent, to receive a trade request for a scheduled-working-shift, via a trading-shift-interface that is running on the computerized-device and associated with a Workforce Management (WFM) system; (ii) retrieving from the database of a plurality of agents with a respective plurality of days-off and scheduled-working shifts, one or more adequate target-agents, which have tagged a period including the scheduled-working shift as tradable via a UI that is associated to the WFM system and having a day off, during the scheduled-working-shift; (iii) calculating a trading-rank to each agent of the one or more adequate target-agents, based on a number of trading actions in a preconfigured period of time in which the adequate target-agent has accepted a trade request. The calculated trading-rank indicates flexibility to trade a scheduled-working-shift. (iv) sorting the one or more adequate target-agents, in descending order according to the calculated trading-rank of each agent of the one or more adequate target-agents, to yield a sorted list of target-agents having a top-ranked target-agent; and (v) automatically updating the database of the plurality of agents with a respective plurality of days off and scheduled-working-shifts, by assigning the scheduled-working-shift of the source-agent to the top-ranked target-agent and the scheduled-working-shift of the top-ranked target-agent to the source-agent.

Furthermore, in accordance with some embodiments of the present disclosure, the trading-shifts module may include: communicating with a computerized-device of a source-agent, to receive a trade request for a scheduled-working-shift, via a trading-shift-interface associated with the computerized-device and then retrieving from the database of a plurality of agents with a respective plurality of days off and scheduled-working shifts, one or more adequate target-agents, having a day off, during the scheduled-working-shift.

Furthermore, in accordance with some embodiments of the present disclosure, the trading-shifts module may further include sorting the one or more adequate target-agents, to yield a sorted list of target-agent, sending the sorted list of target-agents to the computerized-device of the source-agent, to be presented via the trading-shift-interface and upon receiving from the computerized-device of the source-agent, a selection of one or more adequate target-agents from the sorted list of target-agents, presenting a notification for a trade request, on each computerized-device of the selected one or more adequate target-agents, via the trading-shift-interface.

Furthermore, in accordance with some embodiments of the present disclosure, the trading-shifts module may further include automatically presenting the notification for the trade request to a preconfigured number of adequate target-agents are in top of the sorted list of target-agents instead of receiving a selection from the computerized-device of the source-agent.

Furthermore, in accordance with some embodiments of the present disclosure, the trading-shifts module may further include receiving a trade action from each notified one or more adequate target-agents, in response to the notification, for the trade request, via the trading-shift-interface, during a preconfigured time period and sending the trade action to the computerized-device of the source-agent, to be presented, via the trading-shift-interface; and receiving a selection of a scheduled-working-shift of a target-agent, after a preconfigure period of time, from the source-agent, according to the trade action and the scheduled-working-shift.

Furthermore, in accordance with some embodiments of the present disclosure, the sorting of the one or more adequate target-agents, may be performed according to a trading-rank of each agent of the one or more adequate target-agents to yield the sorted list of target-agents.

Furthermore, in accordance with some embodiments of the present disclosure, agents may tag one or more scheduled-working-shifts as tradable via an Employee Engagement Manager (EEM) which is part of Workforce management (WFM) system.

Furthermore, in accordance with some embodiments of the present disclosure, the one or more adequate target-agents may have one or more scheduled-working-shifts, which may be tagged as tradable and the sorting of the one or more adequate target-agents, may be performed according to tagged scheduled-working-shifts of the one or more adequate target-agents, to yield the sorted list of target-agents.

Furthermore, in accordance with some embodiments of the present disclosure, the adequate agents may be agents having a required set of skills for the scheduled-working-shift.

Furthermore, in accordance with some embodiments of the present disclosure, the trading-rank may be calculated based on formula I:

trading_rank=((current_rank*trade_actions)+action_type_weight)/(trade_actions+1) (I)
whereby:
current_rank is a trading-rank of an agent stored in the database of a plurality of agents with a respective plurality of days off and scheduled-working-shifts,
trade_actions is a number of trading actions in a preconfigured period of time,
action_type_weight is a weight assigned to each trade related action.

Furthermore, in accordance with some embodiments of the present disclosure, the presented notification for a trade request may include the source-agent and the scheduled-working-shift of the source-agent.

Furthermore, in accordance with some embodiments of the present disclosure, the computerized device may be at least one of: a mobile device, a tablet, a laptop or a desktop.

Furthermore, in accordance with some embodiments of the present disclosure, the one or more scheduled-working-shifts, that are tagged as tradable, of the one or more adequate target-agents may be during a day off of the source-agent.

Furthermore, in accordance with some embodiments of the present disclosure, the received trade action from each notified one or more adequate target-agents may be at least one of: accept, reject, and when the preconfigured time period has elapsed and no trade action has been selected by a target-agent, in response to the trade request, the trade action may be set to be ignored.

Furthermore, in accordance with some embodiments of the present disclosure, after receiving the selection of the scheduled-working-shift of the target-agent, from the source-agent, trading-shifts module may be updating the database of the plurality of agents with a respective plurality of days off and scheduled-working-shifts, by assigning the scheduled-working-shift of the source-agent to the target-agent and the scheduled-working-shift of the target-agent the source-agent.

Furthermore, in accordance with some embodiments of the present disclosure, when the trading-shifts module may be receiving a trade request from a computerized-device of a source-agent, the trading-shifts module may be further calculating the trading-rank of the source-agent, according to an action-type-weight that has been preassigned to a trade request.

Furthermore, in accordance with some embodiments of the present disclosure, when the trading-shifts module may be receiving a trade action from each notified one or more adequate target-agents, in response to the notification, for the trade request, via the trading-shift-interface, during a preconfigured time period the trading-shifts module may be further calculating the trading-rank of the agent according to an action-type-weight that has been preassigned to trade accepted, when the trade action is trade accepted or trade rejected, when the trade action is trade rejected.

Furthermore, in accordance with some embodiments of the present disclosure, when the trading-shifts module may not receive a trade action from one or more notified agents, in response to the notification for the trade request, during a preconfigured time period, the trading-shifts module may be further calculating the trading-rank of each notified agent that has not responded, according to an action-type-weight that has been preassigned to trade ignored.

Furthermore, in accordance with some embodiments of the present disclosure, a trading-rank for each agent in the database of a plurality of agents with a respective plurality of days off and scheduled-working-shifts, may be set to a preconfigured value before any trade action is performed.

Furthermore, in accordance with some embodiments of the present disclosure, the number of trading actions in the preconfigured period of time in which the adequate target-agent has accepted the trade request, is the number of trading actions in the preconfigured period of time in which the adequate target-agent has accepted the trade request from the source-agent.

There is further provided, in accordance with some embodiments of the present disclosure, a computerized-system for trading a scheduled-working-shift, the computerized-system may include a processor and a memory including a database of a plurality of agents with a respective plurality of days off and scheduled-working shifts which are stored thereon.

Furthermore, in accordance with some embodiments of the present disclosure, the processor may be operating a trading-shifts module. The trading-shifts module may be configured to: (i) communicate with a computerized-device of a source-agent, to receive a trade request for a scheduled-working-shift, via a trading-shift-interface that is running on the computerized-device and associated with a Workforce Management (WFM) system; (ii) retrieve from the database of a plurality of agents with a respective plurality of days off and scheduled-working shifts, one or more adequate target-agents, which have tagged a period including the scheduled-working shift as tradable via a UI that is associated to the WFM system and having a day off, during the scheduled-working-shift; (iii) calculate a trading-rank to each agent of the one or more adequate target-agents, based on a number of trading actions in a preconfigured period of time in which the adequate target-agent has accepted a trade request; The calculated trading-rank indicates flexibility to trade a scheduled-working-shift. (iv) sort the one or more adequate target-agents, in descending order according to the calculated trading-rank of each agent of the one or more adequate target-agents, to yield a sorted list of target-agents having a top-ranked target-agent; and (v) automatically update the database of the plurality of agents with a respective plurality of days off and scheduled-working-shifts, by assigning the scheduled-working-shift of the source-agent to the top-ranked target-agent and the scheduled-working-shift of the top-ranked target-agent to the source-agent.

Furthermore, in accordance with some embodiments of the present disclosure, the trading-shifts module may include communicating with a computerized-device of a source-agent, to receive a trade request for a scheduled-working-shift, via a trading-shift-interface associated with the computerized-device and then retrieving from the database of a plurality of agents with a respective plurality of days off and scheduled-working shifts, one or more adequate target-agents, having a day off, during the scheduled-working-shift.

Furthermore, in accordance with some embodiments of the present disclosure, the trading-shifts module may further include sorting the one or more adequate target-agents, to yield a sorted list of target-agent, sending the sorted list of target-agents to the computerized-device of the source-agent, to be presented via the trading-shift-interface and upon receiving from the computerized-device of the source-agent, a selection of one or more adequate target-agents from the sorted list of target-agents, presenting a notification for a trade request, on each computerized-device of the selected one or more adequate target-agents, via the trading-shift-interface.

Furthermore, in accordance with some embodiments of the present disclosure, the trading-shifts module may further include receiving a trade action from each notified one or more adequate target-agents, in response to the notification, for the trade request, via the trading-shift-interface, during a preconfigured time period and sending the trade action to the computerized-device of the source-agent, to be presented, via the trading-shift-interface; and receiving a selection of a scheduled-working-shift of a target-agent, after a preconfigure period of time, from the source-agent, according to the trade action and the scheduled-working-shift.

### BRIEF DESCRIPTION OF THE DRAWINGS

FIG. 1 schematically illustrates a high-level diagram of a system for trading a scheduled-working-shift, in accordance with some embodiments of the present disclosure;

FIGS. 2A-2D are a high-level workflow of a trading-shifts module, in accordance with some embodiments of the present disclosure;

FIG. 3 is a screenshot depicting a user interface to enable/disable agent trading-rank and working-schedule-shift tagging per site per tenant in a cloud computing environment, in accordance with some embodiments of the present disclosure;

FIG. 4 are screenshots depicting user interfaces of agents tagging their scheduled-working-shifts and target-agents sorted by tagged scheduled-working-shifts, in accordance with some embodiments of the present disclosure;

FIG. 5 are screenshots depicting user interfaces of agent's own ranking and target-agents sorted by trade-ranking, in accordance with some embodiments of the present disclosure; and

FIG. 6 is an example of a trade request that has been accepted, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In current systems in contact centers, when an agent is not available to work on a scheduled-working-shift, the agent may try to trade the scheduled-working-shift with another agent, via a Workforce Management (WFM) system. However, in current WFM solutions, a source-agent has to manually select target-agents having a working-scheduled-shift, with whom the source-agent wants to trade the working-scheduled-shift and to submit a trade request which will notify the selected target-agents.

The current WFM solutions have several deficiencies. First, if none of the target-agents accepts the trade request, then it might result with the source-agent taking a day off during the scheduled-working-shift, which may result with the particular scheduled-working-shift being understaffed. Second, contact center staffing levels may get affected due to an unavailability of agents, because they may be required to perform a manual intervention by a supervisor for searching and reassigning the scheduled-working-shift to other available agents with the same set of skills as the unbailable agent. Third, when the attempt of an agent to trade a scheduled-working-shift fails, it may reduce the flexibility of the source-agent to work with the contact center and even hamper Employee Satisfaction (ESAT) score of the contact center.

Therefore, there is a need for method and system for improving agents' engagement. For example, by increasing the chances that the source-agent will find a target-agent to swap shifts with. The chances that the source-agent will find a target-agent to swap shifts with may be increased by enabling a selection of agents for a scheduled-working-shift for trade, via a Workforce Management (WFM) system, according to agents' availability and also according to agents' trading-rank of shift trade.

In other words, the needed technical solution should provide a mechanism that may reflect target-agents' availability as well as reflecting each target-agent flexibility to swap scheduled-working-shifts thus, elevating the chances that a trade request may be accepted.

Accordingly, there is a need for a technical solution for trading a scheduled-working-shift based on agents' availability to trade a scheduled-working-shift or based on a trading-rank which may reflect the agents' flexibility to trade a scheduled-working-shift.

According to some embodiments of the present disclosure, a computerized system and a computerized method for trading a scheduled-working-shift is provided herein.

According to some embodiments of the present disclosure, the computerized system and computerized method may provide a mechanism that may reflect target-agents' availability to work on the scheduled-working-shift when the source-agent is not available, by allowing agents to tag one or more scheduled-working-shifts, via an Employee Engagement Manager (EEM) system, so that the scheduled-working-shifts may be tagged as available for trading.

According to some embodiments of the present disclosure, the computerized system and computerized method may also provide a mechanism that may reflect each target-agent's flexibility to swap scheduled-working-shifts, by maintaining a trade-ranking mechanism, which may rank agents according to their historical acceptance or failure to notice or to reject scheduled-working-shift trades.

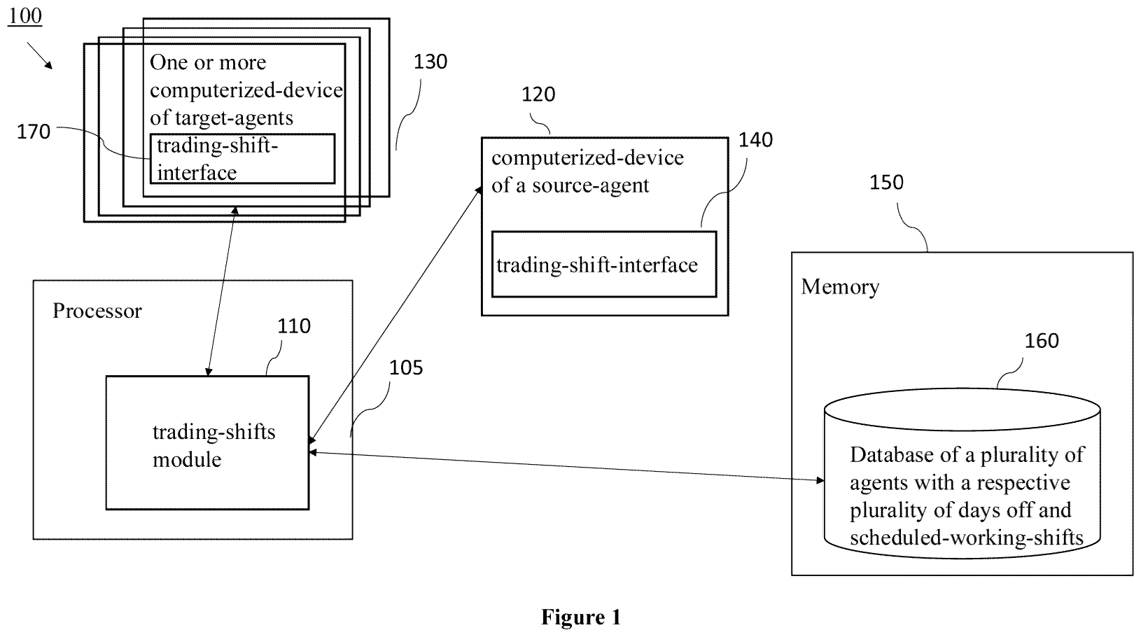

FIG. 1 schematically illustrates a high-level diagram of a system 100 for trading a scheduled-working-shift, in accordance with some embodiments of the present disclosure.

According to some embodiments of the present disclosure, a computerized system, such as system 100, may include a processor 105 and a memory 150. Memory 150 may store a data storage, such as a database of a plurality of agents with a respective plurality of days off and scheduled-working shifts 160.

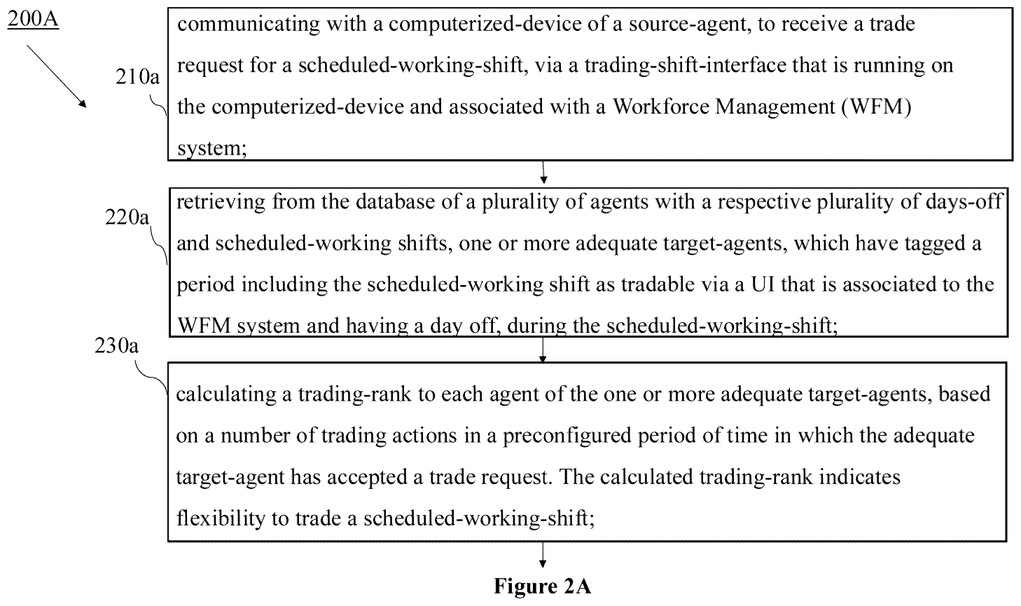

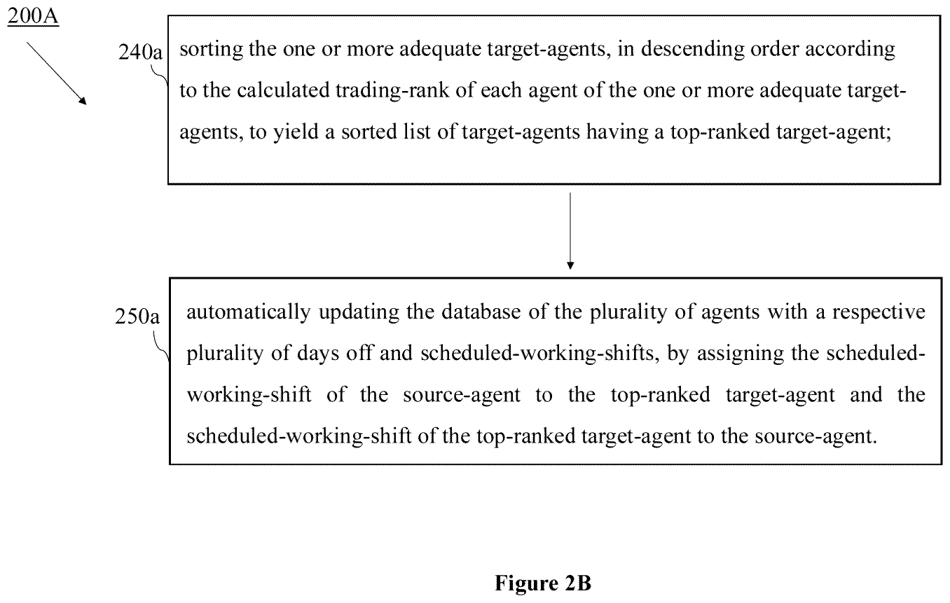

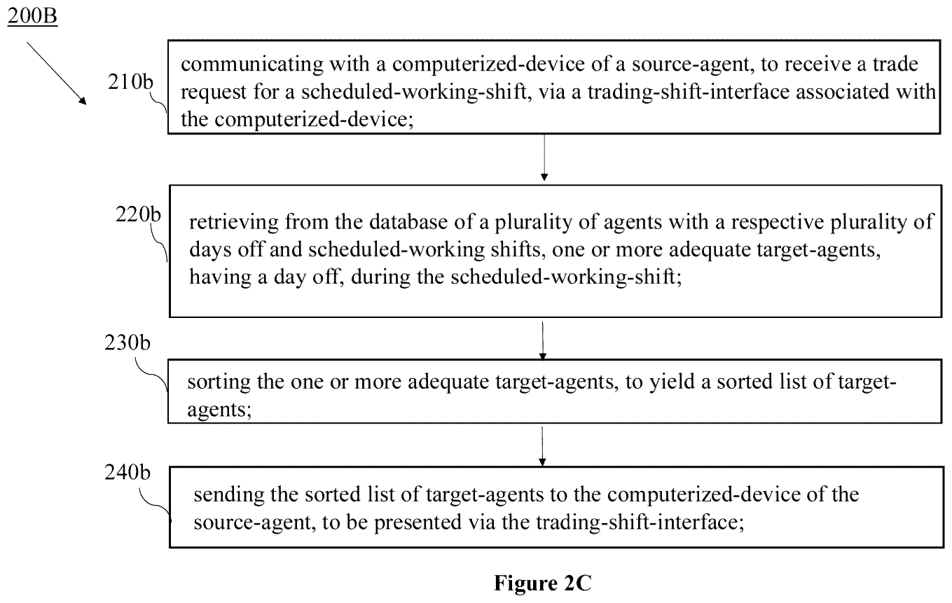

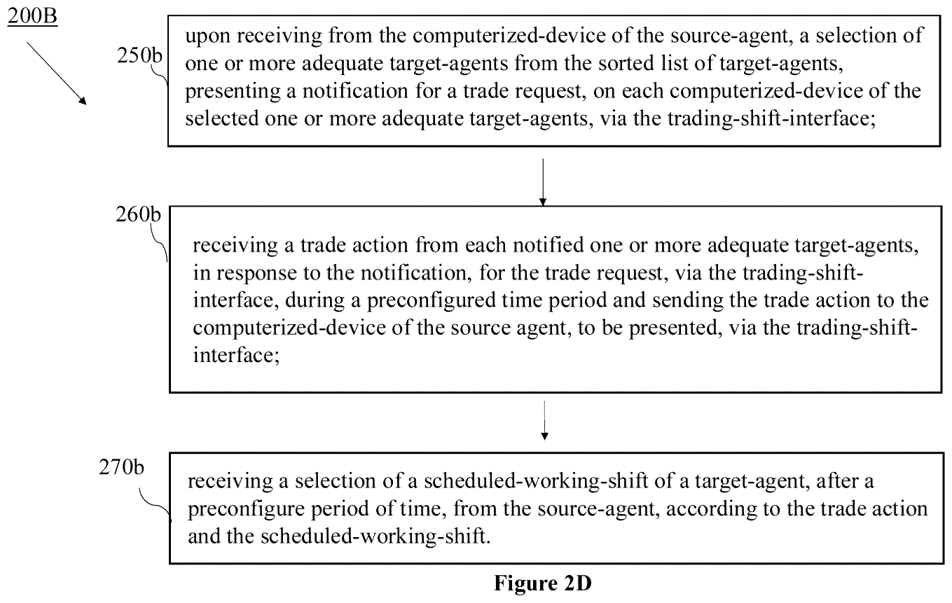

According to some embodiments of the present disclosure, processor 105 may be operating a module such as trading-shifts module 110, such as trading-shifts module 200A in FIGS. 2A-2B and such as trading-shifts module 200B in FIGS. 2C-2D.

According to some embodiments of the present disclosure, the module, such as trading-shifts module 200A in FIGS. 2A-2B and such as trading-shifts module 200B in FIGS. 2C-2D, may include communicating with a computerized-device of a source-agent, such as computerized-device of a source-agent 120, to receive a trade-request for a scheduled-working-shift. The trade-request for a scheduled-working-shift, may be sent to the module, such as trading-shifts module 110, and such as trading-shifts module 200B in FIGS. 2C-2D, via an interface, such as a trading-shift-interface 140, which may be associated with the computerized-device of the source-agent 120. The trade request may be sent via a Workforce Management (WFM) system (not shown), where the interface, such as the trading-shift-interface 140 may be associated to it.

According to some embodiments of the present disclosure, when the module, such as trading-shifts module 110 and such as trading-shifts module 200B in FIGS. 2C-2D, may receive a trade request from a computerized-device of a source-agent 120, the module, such as trading-shifts module 110, may further calculate a trading-rank of the source-agent, based on formula I below, according to an action-type-weight that has been preassigned to a trade request. For example, the action-type-weight that has been preassigned to trade request, may be ‘2’.

According to some embodiments of the present disclosure, when the module, such as trading-shifts module 110, may receive a trade action from each notified one or more adequate target-agents, in response to the notification, for the trade request, via the trading-shift-interface, during a preconfigured time period, the module, such as trading-shifts module 110 and such as trading-shifts module 200B in FIGS. 2C-2D, may further calculate a trading-rank of the target-agent which has accepted, based on action-type-weight of trade accepted, when the trade action is trade accepted or based on action-type-weight of trade rejected, when the trade action is trade rejected. For example, the action-type-weight that has been preassigned to trade accepted may be ‘5’ and the action-type-weight that has been preassigned to trade rejected may be ‘3’.

According to some embodiments of the present disclosure, when the module, such as trading-shifts module 110 and such as trading-shifts module 200B in FIGS. 2C-2D, may not receive a trade action from one or more notified agents, in response to the notification for the trade request, during a preconfigured time period, the module, such as trading-shifts module 110 and such as trading-shifts module 200B in FIGS. 2C-2D, may further calculate the trading-rank of each notified agent that has not responded, according to an action-type-weight that has been preassigned to trade ignored. For example, when a target-agent doesn't respond to the trade request up to 30 minutes, the trade request may expire and the preassigned action-type-weight for trade ignored, may be ‘1’, for calculating the trading-rank of the agent that ignored the trade request.

According to some embodiments of the present disclosure, a trading-rank for each agent in a data storage, such as the database of a plurality of agents with a respective plurality of days off and scheduled-working-shifts 160, may be set to a preconfigured value before any trade action is performed. For example, the preconfigured value may be ‘3’.

According to some embodiments of the present disclosure, the trading-rank may be calculated based on formula I:

trading_rank=((current_rank*trade_actions)+action_type_weight)/(trade_actions+1) (I)

whereby:
current_rank is a trading-rank of an agent stored in the database of a plurality of agents with a respective plurality of days off and scheduled-working-shifts,
trade_actions is a number of trading actions in a preconfigured period of time,
action_type_weight is a weight assigned to each trade related action.

According to some embodiments of the present disclosure, the module, such as trading-shifts module 110 and such as trading-shifts module 200B in FIGS. 2C-2D, may retrieve from a data storage, such as a database of a plurality of agents with a respective plurality of days off and scheduled-working shifts 160, one or more adequate target-agents, having a day off, during the scheduled-working-shift. The adequate agents may be agents having a required set of skills for the scheduled-working-shift. Then, the module, such as trading-shifts module 110 and such as trading-shifts module 200B in FIGS. 2C-2D, may sort the one or more adequate target-agents, to yield a sorted list of target-agents.

According to some embodiments of the present disclosure, the module, such as trading-shifts module 110 and such as trading-shifts module 200B in FIGS. 2C-2D, may send the sorted list of target-agents to the computerized-device of the source-agent 120, to be presented via the trading-shift-interface 140.

According to some embodiments of the present disclosure, upon receiving from the computerized-device of the source-agent 120, a selection of one or more adequate target-agents from the sorted list of target-agents, the module such as trading-shifts module 110 and such as trading-shifts module 200B in FIGS. 2C-2D, may present a notification for a trade request, on each computerized-device of the selected one or more adequate target-agents 130, via each associated trading-shift-interface 170.

According to some embodiments of the present disclosure, the one or more adequate target-agents 130 may be at least one of: a mobile device, a tablet, a laptop or a desktop.

According to some embodiments of the present disclosure, the presented notification for a trade request may include the source-agent and the scheduled-working-shift of the source-agent.

According to some embodiments of the present disclosure, the module, such as trading-shifts module 110 and such as trading-shifts module 200B in FIGS. 2C-2D, may receive a trade action from each notified one or more adequate target-agents, in response to the notification, for the trade request, via the trading-shift-interface, during a preconfigured time period.

According to some embodiments of the present disclosure, the received trade action from each notified one or more adequate target-agents may be at least one of: accept, reject, and when the preconfigured time period has elapsed and no trade action has been selected by a target-agent, in response to the trade request, the trade action may be set to be ignored.

According to some embodiments of the present disclosure, the module, such as trading-shifts module 110 and such as trading-shifts module 200B in FIGS. 2C-2D, may send the received trade action to the computerized-device of the source-agent 120, to be presented, via the trading-shift-interface 140.

According to some embodiments of the present disclosure, the computerized device of the source-agent may be at least one of: a mobile device, a tablet, a laptop or a desktop.

According to some embodiments of the present disclosure, the module, such as trading-shifts module 110 and such as trading-shifts module 200B in FIGS. 2C-2D, may receive a selection of a scheduled-working-shift of a target-agent, after a preconfigure period of time, from the computerized-device of the source-agent 120, according to the trade action and the scheduled-working-shift.

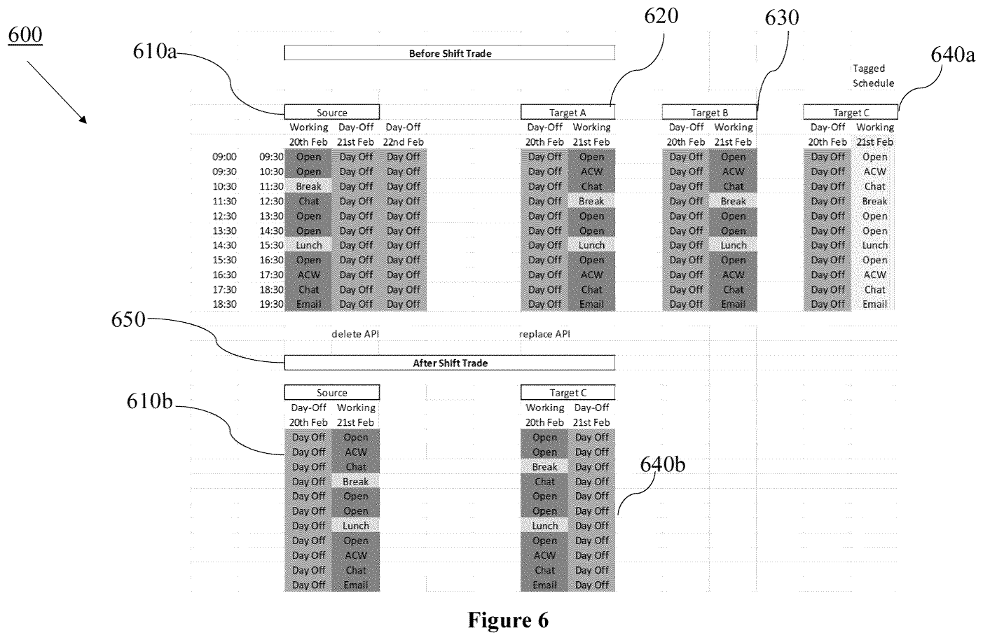

According to some embodiments of the present disclosure, after receiving the selection of the scheduled-working-shift of the target-agent, from the source-agent, updating a data storage, such as the database of the plurality of agents with a respective plurality of days off and scheduled-working-shifts 160, by assigning the scheduled-working-shift of the source-agent to the target-agent and the scheduled-working-shift of the target-agent the source-agent, as shown in detail in example 600 in FIG. 6.

FIGS. 2A-2B are a high-level workflow of a trading-shifts module 200A, in accordance with some embodiments of the present disclosure.

According to some embodiments of the present disclosure, operation 210a may comprise communicating with a computerized-device of a source-agent, to receive a trade request for a scheduled-working-shift, via a trading-shift-interface that is running on the computerized-device and associated with a Workforce Management (WFM) system.

According to some embodiments of the present disclosure, operation 220a may comprise retrieving from the database of a plurality of agents with a respective plurality of days-off and scheduled-working shifts, one or more adequate target-agents, which have tagged a period including the scheduled-working shift as tradable via a UI that is associated to the WFM system and having a day off, during the scheduled-working-shift.

According to some embodiments of the present disclosure, operation 230a may comprise calculating a trading-rank to each agent of the one or more adequate target-agents, based on a number of trading actions in a preconfigured period of time in which the adequate target-agent has accepted a trade request. The calculated trading-rank indicates flexibility to trade a scheduled-working-shift.

According to some embodiments of the present disclosure, operation 240a may comprise sorting the one or more adequate target-agents, in descending order according to the calculated trading-rank of each agent of the one or more adequate target-agents, to yield a sorted list of target-agents having a top-ranked target-agent.

According to some embodiments of the present disclosure, operation 250a may comprise automatically updating the database of the plurality of agents with a respective plurality of days off and scheduled-working-shifts, by assigning the scheduled-working-shift of the source-agent to the top-ranked target-agent and the scheduled-working-shift of the top-ranked target-agent to the source-agent.

According to some embodiments of the present disclosure, optionally, a notification may be automatically sent to a preconfigured number of top-ranked target-agents from the sorted list of target-agents with the trade request details. The notification may be presented on each computerized-device of the selected one or more adequate target-agents, such as one or more computerized-device of target-agents 130 in FIG. 1, via the trading-shift-interface 170 in FIG. 1, each associated with each computerized-device of a target-agent.

FIGS. 2C-2D are a high-level workflow of a trading-shifts module 200B, in accordance with some embodiments of the present disclosure.

According to some embodiments of the present disclosure, operation 210b may comprise communicating with a computerized-device of a source-agent, to receive a trade request for a scheduled-working-shift, via a trading-shift-interface, that may be associated with the computerized-device of the source-agent. The computerized-device of the source-agent may be a computerized-device, such as computerized-device of a source-agent 120 in FIG. 1. The trading-shift-interface may be an interface, such as a trading-shift-interface 140 in FIG. 1 which may be associated with a WFM system that may be operated on the computerized-device of the source-agent.

According to some embodiments of the present disclosure, operation 220b may comprise retrieving from the database of a plurality of agents with a respective plurality of days off and scheduled-working shifts, one or more adequate target-agents, having a day off, during the scheduled-working-shift.

According to some embodiments of the present disclosure, operation 230b may comprise sorting the one or more adequate target-agents, to yield a sorted list of target-agents.

According to some embodiments of the present disclosure, the module, such as trading-shifts module 200A in FIG. 2A-2B and such as trading-shifts module 200B in FIGS. 2C-2D 200B in FIGS. 2C-2D and such as trading-shifts module 110 in FIG. 1, may sort the one or more adequate target-agents, to yield a sorted list of target-agents. The sorted list may reflect the target-agents' flexibility when the sorting of the one or more adequate target-agents, may be performed according to a trading-rank of each agent of the one or more adequate target-agents or may reflect the agent's availability when the sorting of the one or more adequate target-agents, may be performed according to tagged scheduled-working-shifts of the one or more adequate target-agents. The scheduled-working-shifts may have been previously tagged by the one or more adequate target-agents as tradable via an EEM system (not shown).

According to some embodiments of the present disclosure, the one or more scheduled-working-shifts, that are tagged as tradable, of the one or more adequate target-agents are during a day off of the source-agent. The one or more scheduled-working-shifts may be tagged as tradable via an EEM system.

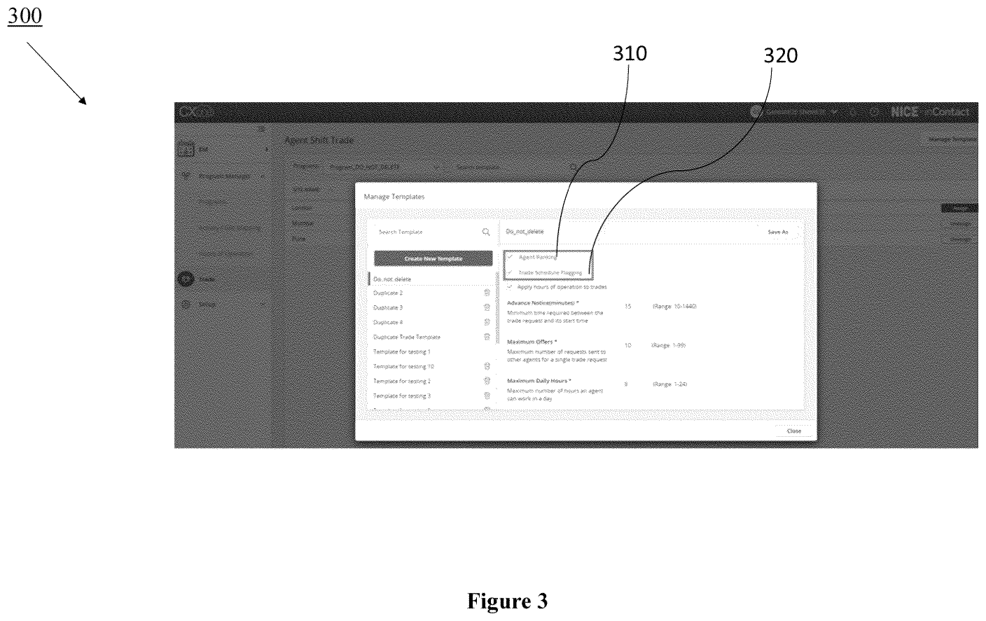

According to some embodiments of the present disclosure, the option to tag scheduled-working-shifts and calculate a trading-rank for each agent may be configured via a user interface per site per tenant in a cloud computing environment. The user interface may be a user interface, such as screenshot 300 in FIG. 3, which is allowing to enable/disable agent trading-rank 310 and to enable/disable working-schedule-shift tagging 320.

According to some embodiments of the present disclosure, operation 240b may comprise sending the sorted list of target-agents to the computerized-device of the source-agent, such as computerized-device of a source-agent 120 in FIG. 1, to be presented via the trading-shift-interface, such as trading-shift-interface 140 in FIG. 1.

According to some embodiments of the present disclosure, operation 250b may comprise, upon receiving from the computerized-device of the source-agent, such as computerized-device of a source-agent 120 in FIG. 1, a selection of one or more adequate target-agents from the sorted list of target-agents, presenting a notification for a trade request, on each computerized-device of the selected one or more adequate target-agents, such as one or more computerized-device of target-agents 130 in FIG. 1, via the trading-shift-interface 170 in FIG. 1, each associated with each computerized-device of a target-agent.

According to some embodiments of the present disclosure, operation 260b may comprise receiving a trade action from each notified one or more adequate target-agents, in response to the notification, for the trade request, via the trading-shift-interface, during a preconfigured time period and sending the trade action to the computerized-device of the source-agent, to be presented, via the trading-shift-interface.

According to some embodiments of the present disclosure, operation 270b may comprise receiving a selection of a scheduled-working-shift of a target-agent, after a preconfigure period of time, from the source-agent, according to the trade action and the scheduled-working-shift.

According to some embodiments of the present disclosure, the preconfigure period of time may be 30 minutes or any other configurable value.

FIG. 3 is a screenshot 300 depicting a user interface to enable/disable agent trading-rank and working-schedule-shift tagging per site per tenant in a cloud computing environment, in accordance with some embodiments of the present disclosure.

According to some embodiments of the present disclosure, when agent ranking 310 and trade scheduled flagging 320 is enabled for a tenant, then each agent in the contact center of the tenant may be enabled to tag specific days, dates and time intervals or an assigned scheduled working shift as tradable via the WFM system.

According to some embodiments of the present disclosure, automated notifications may be sent to target agents which their schedule has been tagged for availability of trade by a source agent. The notifications may be sent in consideration of the schedule preferences of target agents and history of trades between source agent and target agent.

According to some embodiments of the present disclosure, the source agent and the target agent can see the details of previous traded schedules and their status e.g., accepted/rejected/no response. Optionally, the source agent and target agent may block/unblock a person for trade notification based on their preference. If an agent is blocked, then any future notifications for trade from that agent may not be sent to the target agent who has blocked the source agent and vice versa.

According to some embodiments of the present disclosure, optionally, a source agent may select target agents from the list of agents sorted by their schedule tagged preference. Agents that have tagged their schedule as tradable will appear at the top of the target agent list.

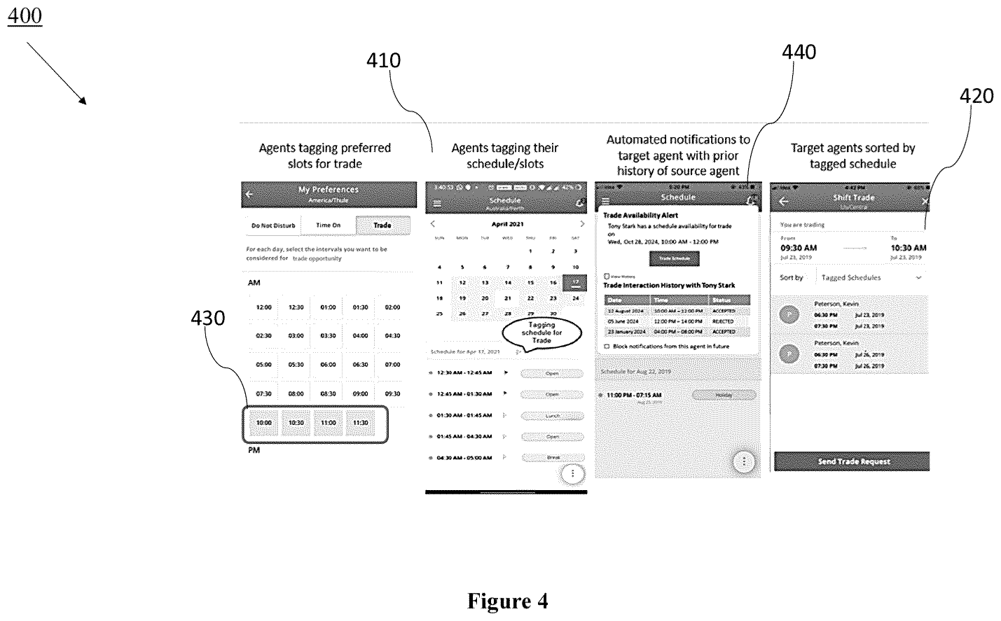

FIG. 4 are screenshots 400 depicting user interfaces of agents tagging their scheduled-working-shifts and target-agents sorted by tagged scheduled-working-shifts, in accordance with some embodiments of the present disclosure.

According to some embodiments of the present disclosure, an agent in the contact center may have the option to tag specific days, dates, time intervals in a working shift as tradable via the WFM system, for example, by clicking on buttons in the UI presenting the time intervals 430.

According to some embodiments of the present disclosure, automated notifications may be sent to target agents when the target agents schedule is tagged for availability of trade by the source agent. The notifications may be sent in consideration of the schedule preferences of target agents and history of trades between the source agent and the target agent.

According to some embodiments of the present disclosure, the source agent and the target agent may be enabled to view details of previous traded schedules and their status, e.g., accepted, rejected or no response 440. The source agent and target agent may be enabled to block or unblock an agent for trade notification based on their preference. If an agent is blocked, then any future notifications for trade from that agent will not be sent to the target agent who has blocked the source agent and vice versa. The source-agent may also be enabled to select target agents from the list of agents sorted by their tagged schedule preference

According to some embodiments of the present disclosure, upon receiving from a computerized-device of a source-agent, such as computerized-device of a source-agent 120, a selection of one or more adequate target-agents from a sorted list of target-agents, a module such as trading-shifts module 110 and such as trading-shifts module 200B in FIGS. 2C-2D, may present a notification for a trade request, on each computerized-device of the selected one or more adequate target-agents 130 in FIG. 1, via each associated trading-shift-interface 170 in FIG. 1.

According to some embodiments of the present disclosure, one or more adequate target-agents may have one or more scheduled-working-shifts, which may be tagged as tradable. The target-agents may have tagged the one or more scheduled-working-shifts, e.g., via an Employee Engagement Manager (EEM) system, to be tagged as tradable, via a user interface, such as user interface 410.

According to some embodiments of the present disclosure, the sorting of the one or more adequate target-agents, such as in operation 230a in FIG. 2A, may be performed according to tagged scheduled-working-shifts of the one or more adequate target-agents, to yield the sorted list of target-agents 420.

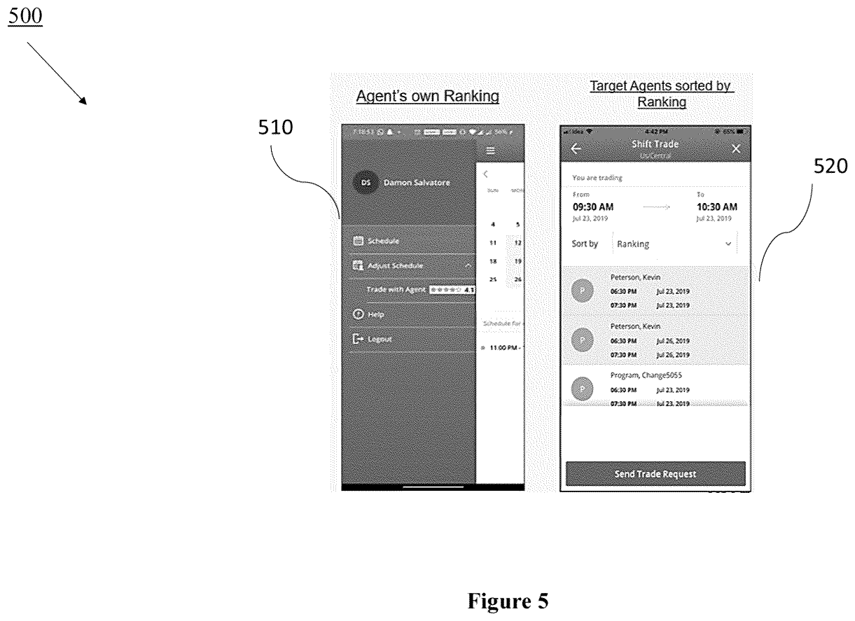

FIG. 5 are screenshots 500 depicting user interfaces of agent's own ranking and target-agents sorted by trade-ranking, in accordance with some embodiments of the present disclosure.

According to some embodiments of the present disclosure, agents trading-rank may reflect the agents' flexibility to trade a scheduled-working-shift. The trading-rank may be higher for target-agents which are willing to accept trade requests and lower for agents which are sending trade requests or ignoring trade requests notifications.

According to some embodiments of the present disclosure, an agent's own ranking may be calculated according to a formula, such as formula I that has been mentioned above.

According to some embodiments of the present disclosure, the sorting of the one or more adequate target-agents, such as in operation 230a in FIG. 2A, may be performed according to a trading-rank of each agent of the one or more adequate target-agents, to yield the sorted list of target-agents. For example, the sorted list may be according to target-agent's trading-rank 520.

FIG. 6 is an example 600 of a trade request that has been accepted, in accordance with some embodiments of the present disclosure.

According to some embodiments of the present disclosure, a source-agent, such as source-agent 610a may send a trade request for scheduled-working-shift on February 20^{th}. The source-agent, such as source-agent 610a may have two days off in which the source-agent may work instead of the scheduled-working-shift on February 20^{th}. The trade request may be sent via an interface that may be associated to a Workforce Management (WFM) system.

According to some embodiments of the present disclosure, a module, such as trading-shifts module 110 in FIG. 1 and trading-shifts module 200B in FIGS. 2C-2D may retrieve from a data storage such as the database of a plurality of agents with a respective plurality of days off and scheduled-working shifts 160 in FIG. 1, one or more adequate target-agents, having a day off, during the scheduled-working-shift, which are target-agents: target-agent ‘A’ 620, target-agent ‘B’ 630 and target-agent ‘C’ 640a. Target-agent ‘C’ has tagged a scheduled-working-shift on February 21^{st}, as tradable. The tagging of a shift as tradable may be performed via an Employee Engagement Management (EEM) system.

According to some embodiments of the present disclosure, the module, such as trading-shifts module 110 in FIG. 1, such as trading-shifts module 200A in FIGS. 2A-2B and such as trading-shifts module 200B in FIGS. 2C-2D may sort the one or more adequate target-agents, to yield a sorted list of target-agents to be sent to the computerized-device of the source-agent 610a, to be presented via a trading-shift-interface.

According to some embodiments of the present disclosure, the module, such as trading-shifts module 110 in FIG. 1 and trading-shifts module 200B in FIGS. 2C-2D may sort the one or more adequate target-agents, according to tagged scheduled-working-shifts of the one or more adequate target-agents, to yield the sorted list of target-agents. Therefore, according to the example, agent ‘C’ 640a may be presented to the source-agent 610a, at the top of the sorted list of target-agents.

According to some embodiments of the present disclosure, upon receiving from the computerized-device of the source-agent 610a, a selection of one or more adequate target-agents from the sorted list of target-agents, the module, such as trading-shifts module 110 in FIG. 1 and trading-shifts module 200B in FIGS. 2C-2D may present a notification for a trade request, on each computerized-device of the selected one or more adequate target-agents, via the trading-shift-interface.

According to some embodiments of the present disclosure, the selection of source-agent 610a may be target-agent ‘C’ 640a or target-agent ‘C’ 640a and other target-agents.

According to some embodiments of the present disclosure, the module, such as trading-shifts module 110 in FIG. 1 and trading-shifts module 200B in FIGS. 2C-2D may receive a trade action from each notified one or more adequate target-agents, in response to the notification, for the trade request, via the trading-shift-interface, during a preconfigured time period and sending the trade action to the computerized-device of the source-agent, to be presented, via the trading-shift-interface.

According to some embodiments of the present disclosure, since target-agent ‘C’ 640a has tagged the scheduled-working-shift as tradable it is most likely that target-agent ‘C’ 640a may accept the trade request. The other target-agents may cither reject, ignore the trade request for the preconfigured time period or accept it.

According to some embodiments of the present disclosure, when the source-agent 610a may select a target-agent, the module, such as trading-shifts module 110 in FIG. 1 and trading-shifts module 200B in FIGS. 2C-2D may receive a selection of a scheduled-working-shift of a target-agent, after a preconfigure period of time, from the source-agent, according to the trade action and the scheduled-working-shift.

According to some embodiments of the present disclosure, after receiving the selection of the scheduled-working-shift of the target-agent, from the source-agent, the module, such as trading-shifts module 110 in FIG. 1 and trading-shifts module 200B in FIGS. 2C-2D may update the data storage, such as database of the plurality of agents with a respective plurality of days off and scheduled-working-shifts 160 in FIG. 1, by assigning the scheduled-working-shift of the source-agent to the target-agent and the scheduled-working-shift of the target-agent the source-agent as shown by element 650 the shifts 610b of source-agent 610a has been updated to a day off on February 20^{th}, and scheduled-working-shift on February 21^{st} and the shifts 640b of target-agent ‘C’ 640a have been updated to a scheduled-working shift on February 20^{th} and a day off on February 21^{st}.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for providing a sorted list of adequate target-agents to a source-agent for trading a scheduled-working-shift, said computerized-method comprising:
in a computerized-system comprising a processor, and a memory including a database of a plurality of agents with a respective plurality of days off and scheduled-working-shifts stored thereon, said processor is operating a trading-shifts module, said trading-shifts module comprising:
(i) communicating with a computerized-device of a source-agent, to receive a trade request for a scheduled-working-shift, via a trading-shift-interface that is running on the computerized-device and associated with a Workforce Management (WFM) system;
(ii) retrieving from the database of a plurality of agents with a respective plurality of days-off and scheduled-working shifts, one or more adequate target-agents, which have tagged a period including the scheduled-working shift as tradable via a UI that is associated to the WFM system and having a day off, during the scheduled-working-shift;
(iii) calculating a trading-rank to each agent of the one or more adequate target-agents, based on a number of trading actions in a preconfigured period of time in which the adequate target-agent has accepted a trade request,
wherein the calculated trading-rank indicates flexibility to trade a scheduled-working-shift,
(iv) sorting the one or more adequate target-agents, in descending order according to the calculated trading-rank of each agent of the one or more adequate target-agents, to yield a sorted list of target-agents having a top-rated target-agent; and
(v) automatically updating the database of the plurality of agents with a respective plurality of days off and scheduled-working-shifts, by assigning the scheduled-working-shift of the source-agent to the top-rated target-agent and the scheduled-working-shift of the top-rated target-agent to the source-agent.

2. The computerized-method of claim 1, wherein the computerized-method further comprising:
(i) sending the sorted list of target-agents to the computerized-device of the source-agent;
(ii) configuring the trading-shift-interface to present the sorted list of target-agents, via the trading-shift-interface on the computerized-device of the source-agent;
(iii) upon receiving from the computerized-device of the source-agent, a selection of one or more adequate target-agents from the sorted list of target-agents, presenting a notification for a trade request, on each computerized-device of the selected one or more adequate target-agents, via the trading-shift-interface;
(iv) receiving a trade action from each notified one or more adequate target-agents, in response to the notification, for the trade request, via the trading-shift-interface, during a first preconfigured time period and sending the trade action to the computerized-device of the source-agent;
(v) configuring the trading-shift-interface to present the trade action, via the trading-shift-interface;
(vi) receiving a selection of a scheduled-working-shift of a target-agent that the received trade action during a first preconfigured time period is accept, after a second preconfigure period of time, from the computerized-device of the source-agent, according to the presented trade action and the scheduled-working-shift of each notified one or more adequate target-agents; and
(vii) updating the database of the plurality of agents with a respective plurality of days off and scheduled-working-shifts, by assigning the scheduled-working-shift of the source-agent to the target-agent and the scheduled-working-shift of the target-agent to the source-agent.

3. The computerized-method of claim 1, wherein the one or more adequate target-agents have one or more scheduled-working-shifts, which are tagged as tradable and wherein the sorting of the one or more adequate target-agents, is performed according to tagged scheduled-working-shifts of the one or more adequate target-agents, to yield the sorted list of target-agents.

4. The computerized-method of claim 1, wherein the adequate agents are agents having a required set of skills for the scheduled-working-shift.

5. The computerized-method of claim 1, wherein the trading-rank is calculated based on formula I:
trading_rank=((current_rank*trade_actions)+action_type_weight)/(trade_actions+1) (I)
whereby:
current_rank is a trading-rank of an agent stored in the database of a plurality of agents with a respective plurality of days off and scheduled-working-shifts,
trade_actions is a number of trading actions in a preconfigured period of time,
action_type_weight is a weight assigned to each trade related action.

6. The computerized-method of claim 1, wherein the presented notification for a trade request includes the source-agent and the scheduled-working-shift of the source-agent.

7. The computerized-method of claim 1, wherein the computerized device is at least one of: a mobile device, a tablet, a laptop or a desktop.

8. The computerized-method of claim 3, wherein the one or more scheduled-working-shifts, that are tagged as tradable, of the one or more adequate target-agents are during a day off of the source-agent.

9. The computerized-method of claim 1, wherein the received trade action from each notified one or more adequate target-agents is at least one of: accept, reject, and wherein when the preconfigured time period has elapsed and no trade action has been selected by a target-agent, in response to the trade request, the trade action is set to be ignored.

10. The computerized-method of claim 1, wherein after receiving the selection of the scheduled-working-shift of the target-agent, from the source-agent, updating the database of the plurality of agents with a respective plurality of days off and scheduled-working-shifts, by assigning the scheduled-working-shift of the source-agent to the target-agent and the scheduled-working-shift of the target-agent the source-agent.

11. The computerized-method of claim 5, wherein when the trading-shifts module is receiving a trade request from a computerized-device of a source-agent, the trading-shifts module is further calculating the trading-rank of the source-agent, according to an action-type-weight that has been preassigned to a trade request.

12. The computerized-method of claim 5, wherein when the trading-shifts module is receiving a trade action from each notified one or more adequate target-agents, in response to the notification, for the trade request, via the trading-shift-interface, during a preconfigured time period the trading-shifts module is further calculating the trading-rank of the agent according to an action-type-weight that has been preassigned to trade accepted, when the trade action is trade accepted or trade rejected, when the trade action is trade rejected.

13. The computerized-method of claim 5, wherein when the trading-shifts module is not receiving a trade action from one or more notified agents, in response to the notification for the trade request, during a preconfigured time period, the trading-shifts module is further calculating the trading-rank of each notified agent that has not responded, according to an action-type-weight that has been preassigned to trade ignored.

14. The computerized-method of claim 5, wherein a trading-rank for each agent in the database of a plurality of agents with a respective plurality of days off and scheduled-working-shifts, is set to a preconfigured value before any trade action is performed.

15. The computerized-method of claim 1, wherein the number of trading actions in the preconfigured period of time in which the adequate target-agent has accepted the trade request, is the number of trading actions in the preconfigured period of time in which the adequate target-agent has accepted the trade request from the source-agent.

16. The computerized-method of claim 2, wherein the trading-shifts module further comprising automatically presenting the notification for the trade request to a preconfigured number of adequate target-agents are in top of the sorted list of target-agents instead of receiving a selection from the computerized-device of the source-agent.

17. A computerized-system for providing a sorted list of adequate target-agents to a source-agent for trading a scheduled-working-shift, the computerized-system comprising:
a processor,
and a memory including a database of a plurality of agents with a respective plurality of days off and scheduled-working shifts stored thereon,
said processor is operating a trading-shifts module, said trading-shift module is configured to:
(i) communicate with a computerized-device of a source-agent, to receive a trade request for a scheduled-working-shift, via a trading-shift-interface that is running on the computerized-device and associated with a Workforce Management (WFM) system;
(ii) retrieve from the database of a plurality of agents with a respective plurality of days off and scheduled-working shifts, one or more adequate target-agents, which have tagged a period including the scheduled-working shift as tradable via a UI that is associated to the WFM system and having a day off, during the scheduled-working-shift;
(iii) calculate a trading-rank to each agent of the one or more adequate target-agents, based on a number of trading actions in a preconfigured period of time in which the adequate target-agent has accepted a trade request;
wherein the calculated trading-rank indicates flexibility to trade a scheduled-working-shift,
(vi) sort the one or more adequate target-agents, in descending order according to the calculated trading-rank of each agent of the one or more adequate target-agents, to yield a sorted list of target-agents having a top-rated target-agent; and
(vii) automatically update the database of the plurality of agents with a respective plurality of days off and scheduled-working-shifts, by assigning the scheduled-working-shift of the source-agent to the top-rated target-agent and the scheduled-working-shift of the top-rated target-agent to the source-agent.
